(19) United States
(12) Patent Application Publication
(10) Pub. No.: US 2012/0188132 A1
(43) Pub. Date: Jul. 26, 2012

(54) Onboard Information System With Mobile Radio Antenna

(75) Inventors: Jens PEULECKE, Villingen-Schwenningen (DE); Torsten WAHLER, Bad Durrheim (DE)

(73) Assignee: Continental Automotive GmbH, Hannover (DE)

(21) Appl. No.: 13/331,924

(22) Filed: Dec. 20, 2011

(30) Foreign Application Priority Data
Dec. 20, 2010 (DE) 10 2010 055 206.2

(51) Int. Cl. H01Q 1/32

(52) U.S. Cl. 343/713

(57) ABSTRACT

An onboard information system having a mobile radio antenna for capturing at least one vehicle-related variable. The onboard information system includes a housing that can be installed in a vehicle interior and a mobile radio module. The mobile radio antenna is positioned in a recess in the housing, and its radiating plane is at a distance from the housing. The onboard information system can be used particularly in a vehicle as a tachograph, preferably as a digital tachograph, and/or a toll collection appliance.

### BACKGROUND OF THE INVENTION

1. Field of the Invention

The present invention relates to an onboard information system having a mobile radio antenna for capturing at least one vehicle-related variable.

2. Description of the Related Art

Onboard information systems, particularly tachographs, toll collection appliances or what are known as universal onboard units, which combine the functions of tachographs and toll collection appliances, must meet ever higher technical demands. Particularly the coupling of such an appliance to an apparatus for receiving mobile radio affords new opportunities for application in this field which allow improved communication between an onboard information system installed in a vehicle, for example a heavy goods vehicle, and various transmitters and/or receivers.

The prior art already discloses such apparatuses. Thus, by way of example, the document EP 1 538 572 A2 discloses a collection appliance for road toll charges in which the collection appliance can be inserted into the housing of a digital tachograph and can use a mobile radio module to transmit data to an external receiver. A drawback of the prior art known to date, however, is that although a mobile radio receiver may be integrated in a housing of an onboard information system, a mobile radio antenna is usually fitted outside of the housing at another position of the vehicle in order to ensure sufficiently strong reception. Electrically conductive portions of the housing can influence the mobile radio antenna during transmitting and receiving such that the signal strength at the mobile radio antenna is too low. Fitting the mobile radio antenna outside of the housing is likewise disadvantageous, however, since, besides mounting the mobile radio antenna, this requires an additional wired or wireless connection to be made between the mobile radio antenna and the mobile radio module accommodated in the housing of the onboard information system. In order to install a mobile radio antenna in an interior of a vehicle, the mobile radio antenna must not have excessive dimensions and must exhibit very good transmission and reception power which is not reduced by other components.

### SUMMARY OF THE INVENTION

The present invention is based on developing an onboard information system which avoids the cited drawbacks.

The invention achieves this object by an onboard information system.

An onboard information system according to the invention is designed to capture at least one vehicle-related variable includes a housing installed in a vehicle interior, a mobile radio module and a mobile radio antenna, wherein the mobile radio antenna is positioned in a recess in the housing. The radiating plane of the mobile radio antenna is at a distance from the housing in this case.

The recess is used for holding the mobile radio antenna such that no edges of the mobile radio antenna protrude, but rather a finish as flush as possible with the rest of the housing is achieved. The mobile radio antenna is therefore firstly positioned on the housing of the onboard information system, as a result of which the positioning of the mobile radio antenna in the recess of the housing forms a compact unit which can easily be installed in the vehicle interior. Secondly, the effect achieved by distancing a radiating plane from the housing is that the radiation and reception characteristics of the mobile radio antenna are good enough to still perform adequately even when it is installed in the vehicle interior.

According to one embodiment of the invention, the advantage of combining all the components which are required for receiving mobile radio in one housing means that the resultant unit can be installed and removed in/from vehicles easily and quickly and at the same time the mobile radio antenna no longer needs to be positioned separately at another position on the vehicle.

In one advantageous development, an electrically conductive part of the housing of the onboard information system and the radiating plane of the mobile radio antenna may be at a distance of at least 50% of an overall height of the mobile radio antenna. In one particularly advantageous development, the distance between the radiating plane of the mobile radio antenna and an electrically conductive part is at least 100% of the overall height of the mobile radio antenna. This distance of at least 50% of the overall height of the mobile radio antenna ensures that the mobile radio antenna can still be installed compactly with the housing, since the dimensions are kept small, but there is also a sufficient distance from electrically conductive parts of the housing which adversely affect the performance of the mobile radio antenna.

In a further advantageous development, the mobile radio antenna may be in the form of a PIFA antenna, that is to say a “Planar Inverted F-shaped Antenna”. A PIFA antenna is generally of planar design comprising a radiating plane and a ground plane arranged essentially parallel thereto, said planes being connected to one another by a short circuit link, and also a supply line for the radiating plane. Such antennas have very good performance characteristics for low production and installation costs, and at the same time the popular dimensions of such an antenna are suited to installation in a vehicle interior. The selection of such an antenna type allows simple positioning of the mobile radio antenna in the recess to be achieved, since firstly the mobile radio antenna can be constructed with appropriately small dimensions and secondly a distance between the radiating plane of the mobile radio antenna and the housing can be easily adjusted.

To improve the transmission and reception characteristics of the mobile radio antenna, the antenna may be fitted on an outer side of the housing. Particularly advantageously, the mobile radio antenna may be directly connected to the housing.

The recess for holding the mobile radio antenna advantageously has an essentially closed surface. This achieves not only increased mechanical robustness as a result of the continuous surface of the housing but also the effect that the mobile radio antenna can easily be mounted on the housing. Alternatively, there may also be a hole provided in the surface of the housing for the recess.

Particularly advantageously, the mobile radio antenna may have dimensions that are less than or equal to dimensions of the recess in the housing. The effect that can be achieved by this is that the mobile radio antenna finishes flush with the housing without adversely affecting the dimensions thereof.

In one embodiment, a base of the mobile radio antenna may be connected to an electrically conductive portion of the housing. The base of the mobile radio antenna, which is in the form of a nonradiating portion of the antenna, can therefore very easily have its surface area connected to an electrical ground for the housing and the mobile radio antenna can therefore perform to the full. The contact face of the base on the housing and the base itself may particularly advantageously be of approximately the same size, which allows particularly space-saving positioning. In this case, it is advantageous to mount the mobile radio antenna directly on the housing, since this means that no antenna power is absorbed by the housing.

The mobile radio antenna may be fitted on a side of the housing remote from the vehicle interior following installation. This makes space for an operator control unit on that side of the housing which faces the vehicle interior, while simultaneously integrating the mobile radio antenna.

Particularly advantageously, the housing may have a cover comprising dielectric material, for example a plastic. This protects the housing against mechanical damage, but at the same time the dielectric material also ensures that there is no shielding by a conductive material. Particularly the mobile radio antenna can be protected by such a cover without adversely affecting the transmission and reception power. At the same time, the cover can ensure that the housing and the cover finish flush and therefore form a compact unit which can easily be installed without hindrance from protruding portions or edges.

In a further advantageous development, the housing can also be installed in a pit having dimensions according to an ISO 7736 standard. As a result, the housing complies with a standard size for installation in consoles in a vehicle, particularly in a radio compartment. The housing of the onboard information system can therefore be installed easily and without difficulty in models from different manufacturers.

In one embodiment, the mobile radio antenna can be connected to a cable, particularly a coaxial cable, the cable being able to be guided through a cutout in the base of the mobile radio antenna into the housing. It is therefore possible to make a reliable connection between the mobile radio antenna and further components positioned inside of the housing without altering the antenna geometry.

Particularly advantageously, an onboard information system having the cited features can be used in a vehicle as a tachograph, particularly as a digital tachograph, and/or as a toll collection appliance, with a combination of the features of tachograph and toll collection appliance prompting the term universal onboard unit. This achieves a technical extension of these appliances.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are illustrated in the drawings and are explained below with reference to FIGS. 1 to 7, in which:

FIG. 1 is a perspective rear view of a housing of an onboard information system having a recess;

FIG. 2 is a mobile radio antenna for integration in an onboard information system;

FIG. 3 is the housing of the onboard information system having an integrated mobile radio antenna;

FIG. 4 is a section through the housing parallel to a rear of the onboard information system having an integrated mobile radio antenna;

FIG. 5 is a further cross section through the housing perpendicularly to the rear of the onboard information system having an integrated mobile radio antenna;

FIG. 6 is the housing of the onboard information system having an integrated mobile radio antenna and also a cover for the mobile radio antenna; and

FIG. 7 shows a perspective front view of the housing of the onboard information system having an integrated mobile radio antenna and a cover.

### DETAILED DESCRIPTION OF THE PRESENTLY PREFERRED EMBODIMENTS

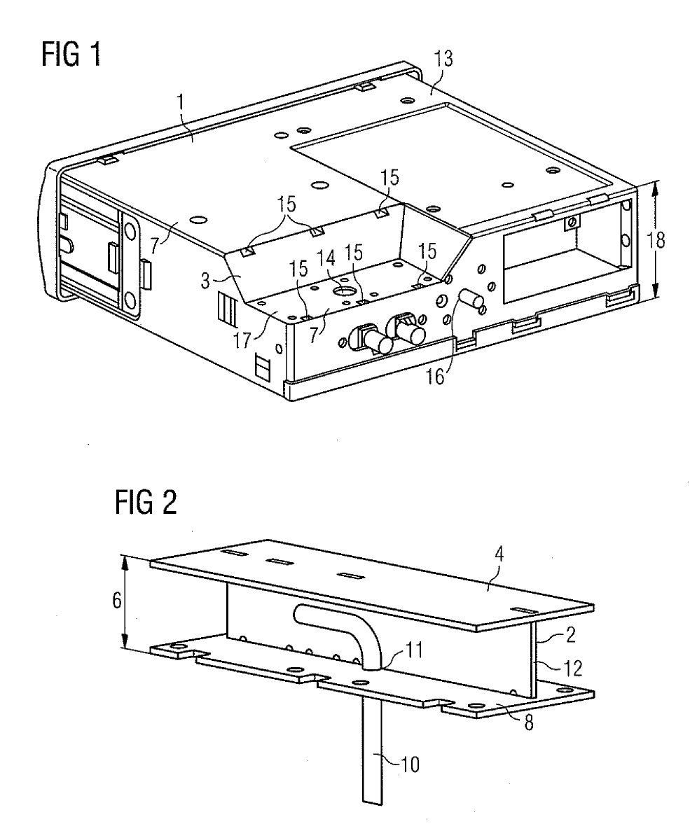

FIG. 1 shows a perspective rear view of a housing 1 for an onboard information system according to the invention, i.e. the side of the housing 1 shown is remote from a vehicle interior or covered by an installation slot following installation. In the case illustrated, the onboard information system is a digital tachograph, but it may also be in the form of a conventional tachograph, a toll collection appliance or in the form of a universal onboard unit. It can be installed in different types of vehicles, both in automobiles and in heavy goods vehicles.

The dimensions of the housing 1 are preferably chosen according to an ISO 7736 or DIN 75490 standard, so that installation in slots, for example radio slots in the dashboard of a vehicle, is possible without difficulty with a multiplicity of models from different manufacturers. The housing 1 comprises a conductive material, in the present case a metal, and has a recess 3 on a top 13 of an outer side 7. Alternatively, the housing 1 may also comprise an electrically nonconductive material. A housing height 18 is 50 mm in the exemplary embodiment shown.

In the region of the recess 3, the housing 1 has a cohesive surface which is integrally connected to the housing 1. The recess 3 has a contact face 17, substantially arranged substantially parallel to a top 13 of the housing 1, for a base of a mobile radio antenna which is connected to the top 13 of the housing 1 by beveled edges. The recess 3 has beveled edges in order firstly to ensure an adequate distance between a mobile radio antenna and the housing 1. Secondly, the beveled edges also provide enough space inside the housing 1 for the installation of further modules or components. In the exemplary embodiment shown, the edges run at an angle of about 45°, but other angles, preferably in the range between about 30° and about 60°, are also possible. In the case shown, the recess 3 is situated at the edge of the housing 1, but the recess 3 may also be situated centrally in the housing 1. The recess 3 may also be parallelepipedal, that is to say may have no beveled edges or alternatively may also have a beveled edge on at least one side and a right-angled edge on at least one other side. A single notch out of the housing 1 in the form of a hole is also covered by the invention as a recess 3, in which case a mobile radio antenna is positioned in the resultant depression.

The onboard information system furthermore comprises a mobile radio module situated inside the housing 1 and is concealed thereby. The recess 3 has been removed from a top 13 at the housing 1 but may likewise be situated on an underside, which is not visible in FIG. 1. The surface of the recess 3 is in the form of a closed surface area, with the contact face 17 of a mobile radio antenna having the same measurements as a base of a mobile radio antenna; the measurements may also be larger than an antenna base. A mobile radio antenna is fitted on that side which is remote from the vehicle interior following installation, in order to allow the installation of display and control elements on the front, but the recess 3 for a mobile radio antenna can be made at any position on the housing 1, that is to say including on a side facing the vehicle interior.

The recess 3 contains a bushing 14 through which a mobile radio antenna positioned in the recess 3 can be connected to components integrated inside of the housing 1. Furthermore, the recess 3 has at least one receptacle 15 for the connection of a cover 9 on the recess 3. In the exemplary embodiment shown in FIG. 1, a plurality of receptacles 15 are included for better mounting. In the case illustrated, the receptacles 15 are designed to hold latching pins on a cover 9, but a screw joint may also be provided for mounting the cover 9 on the housing 1. The receptacles 15 are at a distance of no more than 50 mm in order to avoid long edges, since these edges act as antennas and can therefore interfere with the reception of the mobile radio antenna 2.

Besides the receptacles 15 and the bushing 14 which have already been mentioned, the housing 1 has at least one open area 16 for mounting the housing 1 on a mounting apparatus in the vehicle interior, for example by screwing in a threaded bolt, or for making electrical contact with other components positioned in the vehicle interior.

FIG. 2 shows an exemplary embodiment of a mobile radio antenna 2. In this figure, as in the figures which follow too, identical elements are each provided with the same reference symbols. In the case illustrated in FIG. 2, the mobile radio antenna 2 is in the form of a PIFA antenna, that is to say in the form of a “Planar Inverted F-shaped Antenna”. In this context, a radiating plane 4 is electrically connected to a base 8 by a connecting element 12 which serves as a short circuit line. The radiating plane 4 and the base 8 are arranged parallel to one another, and an overall height 6 is obtained as a distance between a top of the radiating plane 4 and an underside of the base 8. The mobile radio antenna 2 is made from an electrically conductive material, particularly a metal. However, the mobile radio antenna which can be inserted into the recess 3 can also be produced in a different design, for example as a patch antenna.

As a supply line or for the purpose of connection to the mobile radio module or to other modules which may be positioned in the housing 1, the mobile radio antenna 2 comprises a cable 10, in the present case a coaxial cable, which is guided through a cutout 11 which the base 8 of the mobile radio antenna 2 contains. The cable 10 may be soldered, screwed or clamped to the mobile radio antenna 2, particularly to the connecting element 12 or the radiating plane 4.

The surface of the recess 3 contains a bushing 14 corresponding to the cutout 11 for the cable 10. The cutout 11 may be a hole in the base 8, but it may also be a cutout at one edge of the base 8. The diameter of the cutout 11 is preferably only insignificantly larger than the diameter of the cable 10 and of smaller or the same diameter as the bushing 14. If the diameter of the bushing 14 is larger than the diameter of the cutout 11, it is possible to insert an antenna connector through to one end of the cable 10, for example. This design enhances the performance of the mobile radio antenna 2, while the cable 10 fills the only insignificantly larger cutout 11 almost completely and there is therefore no negative influence on the performance, since a portion of the cutout 14 which is not filled by the cable 10 is covered by the base 8.

The mobile radio antenna 2 is suitable for receiving different mobile radio signals, for example signals based on the GSM standard, the GPRS standard, the UMTS standard or another standard. The dimensions of the mobile radio antenna 2 are less than or equal to the dimensions of the recess 3. This ensures that the mobile radio antenna 2 does not protrude from the housing 1, and installation in the vehicle interior is therefore easier to perform.

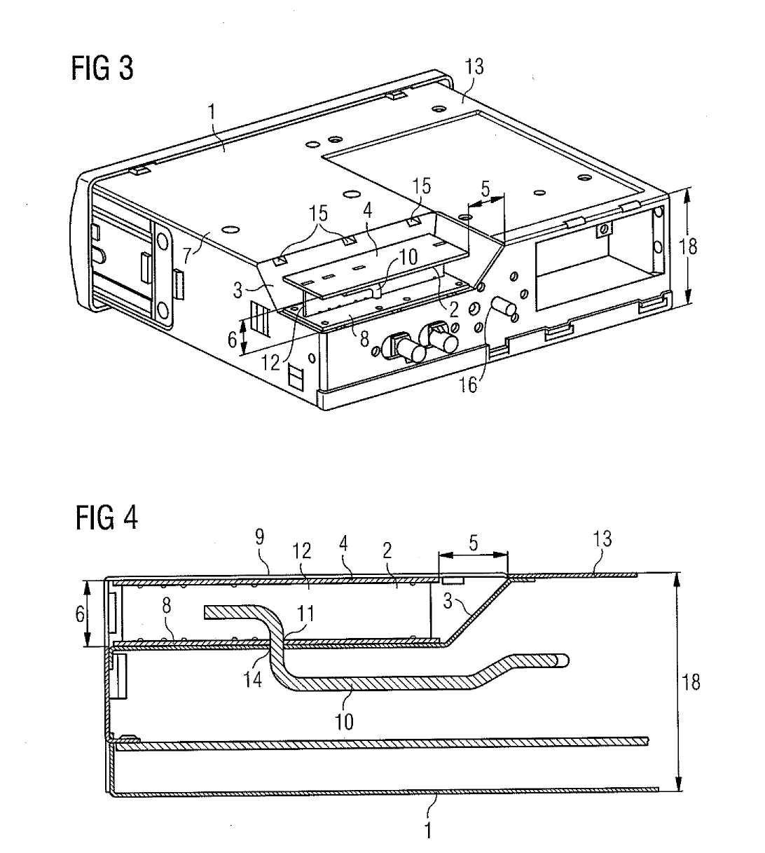

In FIG. 3, the mobile radio antenna 2 shown in FIG. 2 is fitted in the recess 3 on an outer side 7 of the housing 1 of the onboard information system. In this case, the base 8 of the mobile radio antenna 2 has its surface area connected to the outer side 7 of the housing 1, which means that a ground connection is ensured between the base 8, serving as a ground plane for the mobile radio antenna 2, and a ground plane of the housing 1, the latter ground plane being provided by the electrically conductive outer side 7 of the housing 1. The cable 10 is guided through the cutout 11 and the bushing 14 into the interior of the housing 1. The antenna can be connected by riveting, soldering, screwing, or adhesive bonding. The dimensions of the mobile radio antenna 2 are less than or equal to the dimensions of the recess 3. This means that the housing 1 can be installed in a slot having dimensions according to ISO 7736 or DIN 75490 even with an integrated mobile radio antenna 2.

The top of the radiating plane 4 is at the same height as the top 13 of the housing 1 or slightly below the top 13. The radiating plane 4 of the mobile radio antenna 2 is fitted at a distance 5 from the surface of the recess 3. In the case shown, the distance 5 is approximately 100% of the overall height 6 of the mobile radio antenna 2, which means that radiation is not hampered, and is of the same magnitude both on the longitudinal side and on the transverse side of the radiating plane 4. However, the distance 5 also does not need to be of the same magnitude on all sides provided that the cited minimum distance is not transgressed in each case. Therefore, a relatively high level of variability is achieved for the integration of further modules in the interior of the housing 1.

The surface area of the base 8 covers the bushing 14 in the housing 1, which means that the performance of the mobile radio antenna 2 is not impaired by the bushing 14 having a greater diameter than the diameter of the cutout 11.

Even with other shapes for the recess 3, for example a notch out of the housing 1, the radiating plane 4 of the mobile radio antenna 2 firstly does not protrude over the dimensions of the housing 1, in order to ensure simple installation, but secondly is at a sufficient distance 5 from an electrically conductive portion of the housing 1 and is also positioned as close as possible to the outer side 7 of the housing 1. This achieves transmission and reception characteristics of appropriate quality for the mobile radio antenna 2 in a compact design. These prerequisites should be realized regardless of the design of the mobile radio antenna 2, that is to say that when a patch antenna is used, for example, the radiating plane 4 thereof must likewise be at a distance 5 from electrically conductive portions of the housing 1 and allow a flush finish with the housing 1.

FIG. 4 shows a section through the housing 1 parallel to the rear of the housing 1. The cable 10 is connected to the mobile radio antenna 2 and is guided through a cutout 11 in the base 8 of the mobile radio antenna 2 and through the bushing 14 into the interior of the housing 1. The recess 3 preferably has beveled edges in order to ensure a distance 5 which, as already explained, is approximately 100% of the overall height 6 of the mobile radio antenna 2 between the radiating plane 4 and the housing 1. The base 8 of the mobile radio antenna 2 is mounted flush on a surface of the recess 3. The dimensions of the base 8 and of the contact face of the base 8 on the recess 3 are of essentially the same magnitude. This allows good contact to be produced with little space requirement.

In addition, the mobile radio antenna 2 is protected against mechanical damage by a cover 9. The cover 9 has latching pins introduced into the receptacles 15 and latch therein. This allows a reliable connection to be made, with the cover 9 also being able to be easily released. Alternatively, provision may also be made for the cover 9 to be mounted by screws, a magnetic connection, adhesive bonding, riveting or other connection mechanisms. The rest of the housing 1 can also be protected against mechanical damage by a cover.

The cover 9 is made of a dielectric material, that is to say a material which is not or only slightly electrically conductive, in the present case plastic, in order to avoid negatively influencing the transmission and reception characteristics of the mobile radio antenna 2. In the exemplary embodiment shown, the cover 9 is in contact with the radiating plane 4 of the mobile radio antenna 2, but it is also conceivable for an interspace to be permitted between the two portions. The cover 9 continues the top 13 of the housing 1 flush, so that a planar surface is obtained, but the cover 9 may also be situated below the top 13 of the housing 1, so that a step or bevel is produced between the cover 9 and the top 13. This results in an essentially parallelepipedal housing 1 with a cover 9, which housing is easy to install and remove.

FIG. 5 is a section through the housing 1 perpendicular to the rear of the housing 1. In this figure too, the distance 5 between the radiating plane 4 and the housing 1, particularly an electrically conductive part of the housing 1, is approximately 100% of the overall height 6 of the mobile radio antenna 2.

The cable 10 is in direct contact with a connecting element 12 between the radiating plane 4 and the base 8 and is guided through the cutout 11 on this connecting element 12 into the interior of the housing 1. The cover 9 in turn covers the entire recess 3, including the mobile radio antenna 2, and thus ensures a flush connection to the outer side 7 of the housing 1.

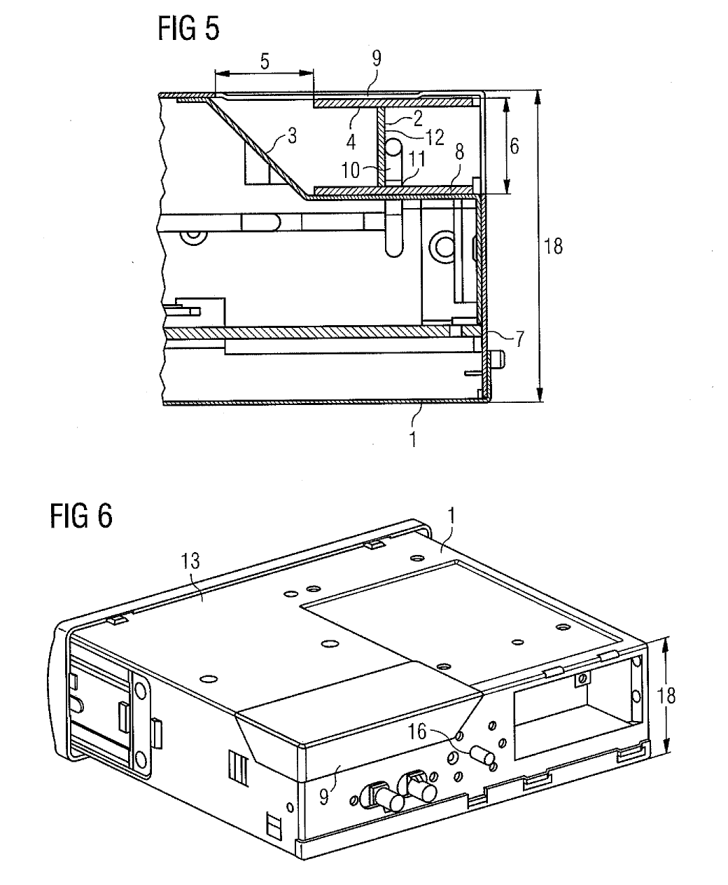

FIG. 6 shows the housing 1 of the onboard information system from the same perspective as FIG. 1. The mobile radio antenna 2 is now concealed beneath the cover 9. The cover 9 provides a flush connection to the shape of the housing 1, so that even with the cover 9 the dimensions are suitable for installation in a slot according to ISO 7736 or DIN 75490. In the case of an installation in a slot in a dashboard in a vehicle, the distance between the mobile radio antenna 2 and further electrically conductive portions of other installed appliances which may cover the mobile radio antenna 2 (e.g. a radio) should be at least 20 mm, in order to be able to send and receive signals at sufficient strength.

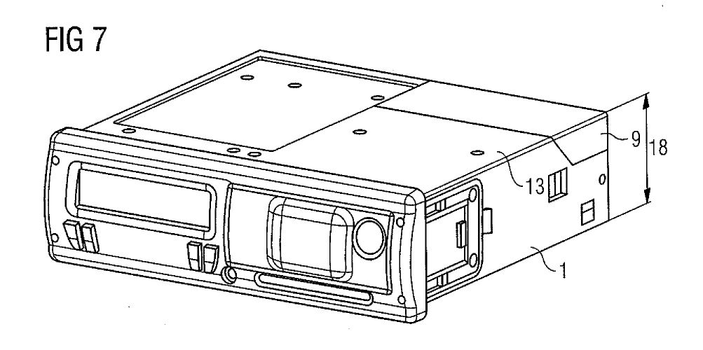

FIG. 7 shows the front, which is the opposite end side of the housing 1 shown in a rear view in FIG. 6 of the onboard information system that faces a vehicle interior following installation. Such a housing 1 with an integrated mobile radio antenna 2 for an onboard information system can be used to produce a compact housing 1 which is suitable for installation in different types of vehicles without fitting supplementary modules or external antennas. In addition, replacement by the standard measurements is simple and quick to perform.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An onboard information system for capturing at least one vehicle-related variable, comprising:
a housing having a recess configured to be installed in a vehicle interior;
a mobile radio module; and
a mobile radio antenna, positioned in the recess in the housing, a radiating plane of the mobile radio antenna being arranged at a distance from the housing.

2. The onboard information system as claimed in claim 1, wherein an electrically conductive part of the housing and the radiating plane of the mobile radio antenna are at a distance of at least 50% of an overall height of the mobile radio antenna.

3. The onboard information system as claimed in claim 1, wherein the mobile radio antenna is a PIFA antenna.

4. The onboard information system as claimed in claim 1, wherein the mobile radio antenna is arranged on an outer side of the housing.

5. The onboard information system as claimed in claim 1, wherein the mobile radio antenna has dimensions which are less than or equal to dimensions of the recess.

6. The onboard information system as claimed in claim 1, wherein a base of the mobile radio antenna is connected to an electrically conductive portion of the housing.

7. The onboard information system as claimed claim 1, wherein the mobile radio antenna is arranged on a side of the housing remote from a vehicle interior following installation in a vehicle.

8. The onboard information system as claimed in claim 1, wherein the at least the recess has a cover comprising a dielectric material.

9. The onboard information system as claimed in claim 1, wherein the housing is configured to be installed in a pit having dimensions according to an ISO 7736 standard.

10. The onboard information system as claimed in claim 6, further comprising:
a cable connected to the mobile radio antenna, the cable being guided through a cutout in the base of the mobile radio antenna into the housing,
wherein the base covers a surface area of the cutout that is not filled by the cable.

11. The onboard information system as claimed in 1, wherein the onboard information system is configured as at least one of a tachograph, a digital tachograph, and a toll collection appliance.

12. The onboard information system as claimed in claim 2, wherein the electrically conductive part of the housing and the radiating plane of the mobile radio antenna are at a distance of at least 100% of an overall height of the mobile radio antenna.

13. The onboard information system as claimed in claim 4, wherein the mobile radio antenna is preferably directly connected to the outer side.

14. The onboard information system as claimed in claim 8, wherein the dielectric material is plastic.

15. The onboard information system as claimed in claim 10, wherein the cable is a coaxial cable.
